(19) United States
(12) Patent Application Publication
(10) Pub. No.: US 2007/0123174 A1
(43) Pub. Date: May 31, 2007

(54) Device and method for single connector access to multiple transceivers

(76) Inventors: Randy A. Wiessner, Palatine, IL (US); Istvan J. Szini, Grayslake, IL (US)

Correspondence Address: MOTOROLA INC, 600 NORTH US HIGHWAY 45, ROOM AS437, LIBERTYVILLE, IL, 60048-5343, US

(21) Appl. No.: 11/287,617

(22) Filed: Nov. 28, 2005

(51) Int. Cl. H04B 1/38

(52) U.S. Cl. 455/73

(57) ABSTRACT

Disclosed are communication devices that combine at least two antenna paths to a single RF connector having a single probe port for testing and connecting accessories. Prior to insertion of a probe, the transceivers are coupled to their respective antennas. When the probe is inserted into the probe port, the connector is activated, so that both transceivers send signals to and receive signals from the single probe port. Also disclosed is a method for testing an electronic device. The method includes powering up the plurality of transceivers, and engaging the probe port with a probe so as to perform testing. Engaging the probe port with the probe decouples the plurality of transceivers from the plurality of antennas and couples the plurality of transceivers through respective diplexing networks to the probe part.

### FIELD

The present disclosure relates to testing of electronic devices, and more particularly to a single connector providing access to multiple transceivers for testing a mobile communication device.

### BACKGROUND

Designers and manufacturers of mobile electronic devices, and in particular, cellular telephones are developing smaller and smaller devices. The aesthetics of the devices has become increasingly important as well. Designers and manufacturers are seeking ways to make the smaller devices even more attractive.

With the advent of Bluetooth and WIFI, the smaller devices include many more communication components than their larger counterparts. Oftentimes, cellular telephones are made with at least two transceivers and their respective antennas, such as a standard cellular transceiver, and for example an additional transceiver/antenna pair for a Bluetooth communication link. As more devices with additional wireless communication links become available, such as UMTS, GSM, GPS, WLAN, international links and Bluetooth, these small devices may need to come equipped with even more than two transceivers.

While the sizes of many components of the devices are made smaller, certain functional features have remained the same in the devices. For testing and accessory purposes, cabled access is used to some or all of the antenna paths through radio frequency (RF) connectors which are accessible external to the phone. For example, cellular telephones may have probe ports that can be used during the testing process at the manufacturing or distribution phase. A probe may be inserted into the device in a probe port of a connector to test the reception and transmission of a particular transceiver. Also, a probe may be inserted into the device in the device for connection of an accessory, for example, a hands-free car kit with external antennas.

If each of the plurality of transceiver/antenna pairs were to require a connector (probe port) for testing, the small devices would have too many probe ports for good aesthetics and product size. It may be difficult to arrange several or more probe ports since each connector should be placed symmetrically and covered externally to make an aesthetically pleasing cellular telephone. Moreover, each additional connector added populates more area of the printed circuit board of the device and adds additional cost. It would be beneficial if there were fewer probe ports for aesthetic reasons and fewer connector components on the printed circuit board within the cellular telephone housing to reduce size and costs.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an illustration of a mobile communication device with some of its components;

FIG. 2 shows a circuit diagram of the connector without a probe inserted into the probe port;

FIG. 3 show a circuit diagram of the connector with a probe inserted into the probe port;

FIG. 4 shows the connector of FIG. 3 incorporated into a circuit including two antennas and their two respective transceivers; and

FIG. 5 shows an embodiment of a method including inserting the probe for testing of an electronic device.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Disclosed are communication devices that combine at least two antenna paths to a single RF connector. Therefore, testing of a communication device and connecting accessories to a plurality of transceivers and a plurality of antenna paths of the communication device may be effected through a single probe port and a single connector.

Prior to insertion of the probe into the probe port, the transceivers are coupled to their respective antennas. When the probe is inserted into the probe port, the connector is activated, so that both transceivers send signals to and receive signals from the single probe port.

Upon testing, the activated connector operatively disconnects the first transceiver from its antenna so that it can receive and send signals through a first diplexer to the probe. A switch may disconnect the second transceiver from its antenna so that the transceiver can send signals to and receive signals from the connector through a second diplexer.

Also disclosed is a method for testing an electronic device. The method includes powering up the plurality of transceivers, and engaging the probe port with a probe so as to perform testing. Engaging the probe port with the probe decouples the plurality of transceivers from the plurality of antennas and couples the plurality of transceivers to the probe port.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

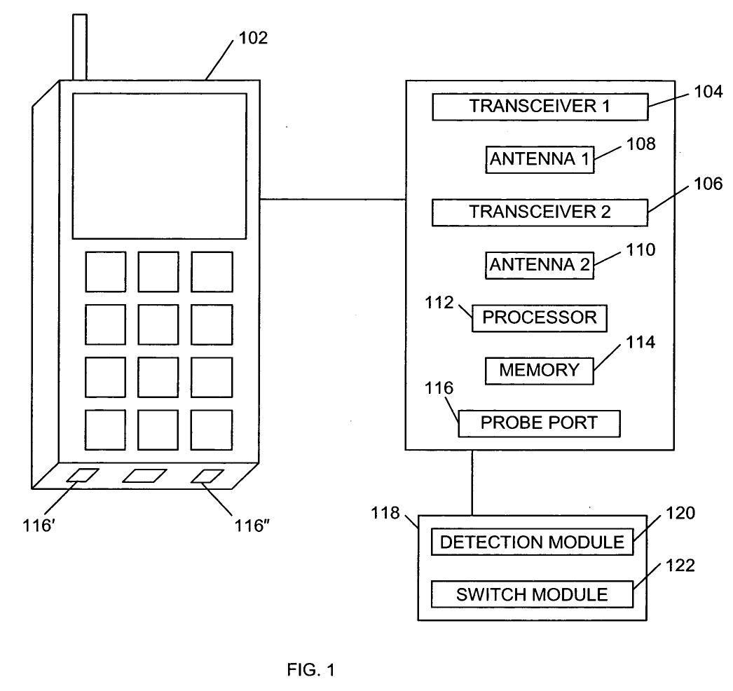

FIG. 1 is an illustration of a mobile communication device with some of its components. The mobile communication device 102 represents a wide variety of communication devices that have been developed for use within various networks. Such handheld communication devices include, for example, cellular telephones, messaging devices, mobile telephones, personal digital assistants (PDAs), notebook or laptop computers incorporating communication modems, mobile data terminals, application specific gaming devices, video gaming devices incorporating wireless modems, and the like. Any of these portable devices may be referred to as a mobile station or user equipment. The electronic device 102 includes at least two transceivers (transmitter and receiver) 104 and 106, at least two antennas 108 and 110, a processor 112, a memory 114, and a probe port 116. The probe port 116′ is shown on the exterior of device 102 as well. A second probe port 116″ symmetrically positioned to probe port 116′ is also shown.

Two probe ports are shown to illustrate that with more than one probe port, at least four transceivers can be operable in the device. Additionally, were the single connector circuits as described herein to include three or more transceivers coupled to a single connector (with its probe port), a device with two probe ports, and two connectors, can include six of more transceivers. Similarly, if a single connector were in communication with four or more transceivers, the device with two probe ports could support as many as eight or more transceivers. It is understood that the number of transceivers coupled to a single connector is not limited by the described dual transceiver circuit. The connector may also be referred to herein as a radio frequency (RF) connector.

The transceivers 104 and 106 can provide a communication link of any type. As mentioned above, mobile communication devices may include a variety of transceivers. It is understood that while the figures of the circuit as described below are with reference to two transceivers, more than two transceivers and their respective circuitry are within the scope of this discussion. It is further understood that the disclosed devices and methods may be adapted to include more than two transceivers coupled with a single probe.

The modules 118 may contain instruction modules that are hardware or software. As will be described in more detail below, a detection module 120 and a switch module 122 can control the single connector circuit. Of course, other hardware or software controls may be included in the described technology.

When a probe is not inserted into any probe port, for example probe port 116, the device, when powered, may be transmitting and receiving via the at least two antennas 108 and 110 and their respective transceivers 104 and 106. The circuits are independent from one another in that they have no immediate electrical connection, as explained in more detail below.

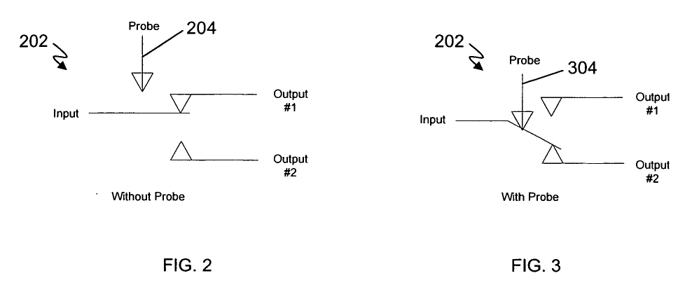

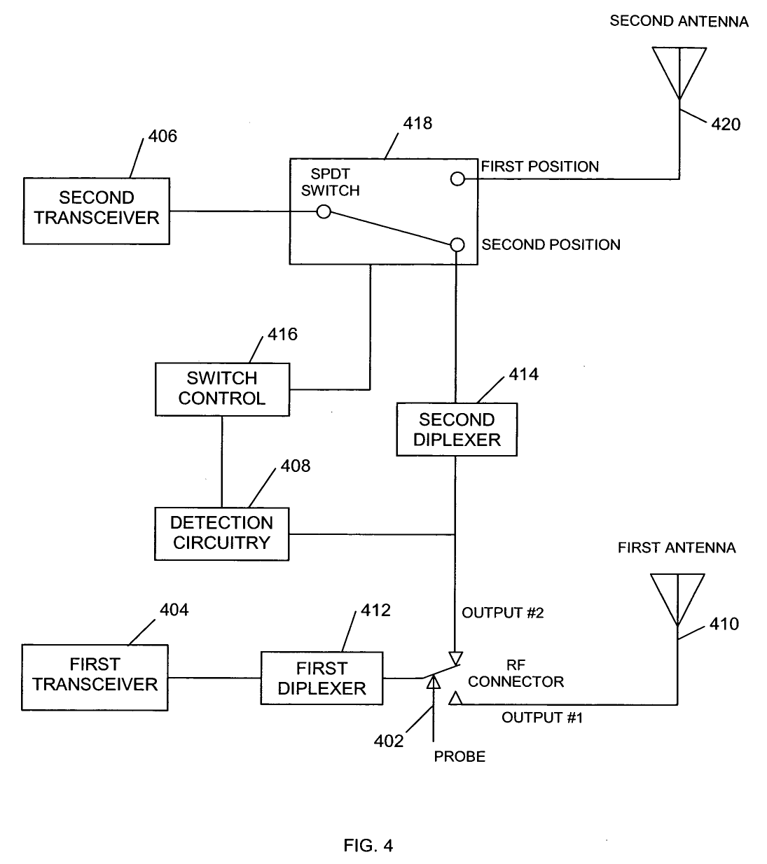

FIG. 2 and FIG. 3 show two circuit diagrams of a connector including a probe port for engaging the probe of the disclosed technology. FIG. 2 shows the connector circuit 202 prior to the insertion of the probe 204 into the probe port (see probe ports 116, 116′ and 116″ of FIG. 1). Prior to insertion of the probe, the connector connects the input signal to output #1. The output #1 of FIG. 2 and FIG. 3 may, for example, connect to a first antenna as shown in FIG. 4. FIG. 3 shows the connector circuit 202 after the insertion of the probe 304 into the probe port. After the insertion of the probe, the connector connects the input signal to output #2. The output #2 of FIG. 2 and FIG. 3 may, for example, make a connection to multiple transceivers as shown in FIG. 4 and in accordance with this disclosure. It will be appreciated that the terms input and output in the discussion of FIGS. 2 and 3, and elsewhere in this disclosure, are used for clarity, and not intended to suggest that signals flow solely from input to output.

When the probe is first inserted into the probe port, the RF connector can be disconnected from output #1 by the force of the probe insertion. As shown in FIG. 3, when the probe is fully inserted into the probe port, the input of the RF connector can be connected to the probe and also to the output #2. As a result, the probe can be coupled to a plurality of transceivers, in this case, one transceiver providing signals to, and receiving signals from the input of the connector, and the other transceiver providing signals to, and receiving signals from output #2 of the RF connector. As shown in FIGS. 2 and 3, the RF connector first completes the connection between the probe 202 with the input and output #1 before breaking the connection with output #1 and thereafter making the connection with output #2. With the connections made and broken in this order, connecting the probe simultaneously with both internal antennas to the transceivers can be avoided. The probe may be connected to one or more external antennas. Thus, with this connection configuration, an abrupt load mismatch may be avoided.

FIG. 4 shows the connector configuration of FIG. 3 incorporated into a circuit including two transceivers and their respective antennas. That is, a probe 402 is inserted into the probe port of the RF connector, corresponding to the probe shown in FIG. 3. In this manner both transceivers 404 and 406 are coupled to the probe 402. The first antenna that is on the lead for output #1 is disconnected from the first transceiver.

FIG. 4 shows detection circuitry 408. Once inserted into the probe port as shown in FIG. 3, the probe can be detected by detection circuitry. Detection of the probe 402 can be done, for example, by mechanically detecting a second RF path at the RF connector. Detection of the probe can also be carried out by capacitively detecting the second RF path. Detecting the presence of the probe may be implemented, as previously mentioned, using hardware or software. (See detection module 120 of FIG. 1.) FIG. 4 further illustrates that engaging the probe port of the connector 410 with the probe can decouple a plurality of transceivers from the plurality of antennas and can couple the plurality of transceivers to the probe port.

The probe is initially coupled to a first transceiver 404 through a first diplexing network 412. A diplexing network may connect two or more circuit components and operates to substantially pass signals in a first predetermined range of frequencies (in-band signals) while at the same time substantially blocking passage of signals in a second predetermined range of frequencies (out-of-band signals). Signals in the frequency range at which the first transceiver 404 transmits and receives are in-band for the first diplexing network 412. Signals in the frequency range at which a second transceiver 406 transmits and receives are out-of-band for the first diplexing network.

A second diplexing network 414 may keep the signal intended for the testing and/or operation of the first transceiver 404 from reaching the second transceiver 406. That is, signals in the frequency range at which the first transceiver 404 transmits and receives are out-of-band for the second diplexing network 414. Signals in the frequency range at which a second transceiver 406 transmits and receives are in-band for the second diplexer.

But for the first diplexing network 412 and the second diplexing network 414, signals from each transceiver would be applied to the output of the other transceiver when the probe 402 is inserted. Also, were it not for the first diplexing network 412 and the second diplexing network 414, signals from the probe in a frequency band intended for one of the transceivers would be applied to the other transceiver as well. Without a diplexer, a signal injected by probe 402 could be split between both transceivers, which may overly load the signal source connected to the probe providing the signal for injection. Also, without a diplexer, the transmitter of one transceiver may be hard connected with the receiver of the other transceiver, and vice-versa. A diplexer can increase the isolation between transceivers and may protect filters in the transceivers from loading.

The first diplexing network 412, for example, is configured to substantially pass to the connector signals of a first frequency between the probe and the first transceiver 404, while the second diplexing network 414 is configured to substantially block those signals from reaching the second transceiver 406. Likewise, when a second frequency intended for the second transceiver 406 is sent to and/or received by the probe, the second diplexing network 412, for example, is configured to substantially pass to the connector signals of the second frequency between the probe and the second transceiver 404, while the first diplexing network 414 is configured to substantially block those signals from reaching the first transceiver 406.

In the course of insertion of the probe 402, the RF connector decouples the first transceiver 404 from the first antenna 410, and the probe is coupled to the first transceiver, and testing operations may be performed or the probe may couple the first transceiver to an accessory. In that case, the second diplexer 414 may keep the signal between the probe and the first transceiver 404 from reaching the second transceiver 406 since the signal intended for the first transceiver would otherwise be applied to the second transceiver but for the second diplexing network 414. When the probe is removed, probe is decoupled from the first transceiver and the RF connector couples the first transceiver to the first antenna.

After the probe is inserted, and the probe is detected by the detection circuitry 408, the switch control 416 can engage the switch 418 which may be a single pole double throw (SPDT) type of switch. The switch can be toggled by either hardware or software instruction to change the switch from a first position to a second position. In the second position, the second transceiver 406 is disconnected from the second antenna 420 and coupled to the probe. The probe itself may be coupled to a testing circuit, or may be coupled to an accessory device of the mobile communication device 102 of FIG. 1, for example, a hands-free car kit with external antennas. The switch module 112 of FIG. 1 can provide instructions for the toggling of switch 418 from the first position to the second position and for the toggling of the switch from the second position to the first position. The switch 418 may be thrown every time that a probe or accessory is inserted, as soon as physically possible.

When the switch 418 is toggled from the first position to the second position, the probe 402 is coupled to second transceiver 406 and testing operations may be performed, or the probe may couple the second transceiver to an accessory. In that case, first diplexing network 412 may keep the signal between the probe and the second transceiver 406 from reaching the first transceiver 404 since the signal intended for the second transceiver would otherwise be applied to the first transceiver but for the first diplexing network 412. When the probe is removed, the switch returns to the first position and couples the second transceiver 406 to the second antenna 420. Also, the connector reverts to its position where the first transceiver 404 is coupled to the first antenna 410.

The operation just described may work in the opposite order. That is, upon insertion of the probe, the switch moves from the first position to the second position. The testing operation on second transceiver 406 may be performed first. Which of the transceivers is under test may be determined by the probe signal.

As previously discussed, a diplexing network as described herein is configured to substantially pass to the connector signals between the probe and one transceiver and to substantially block signals between the probe and another transceiver. A diplexing network may be comprised of in one exemplary embodiment as an LC circuit or a transmission line circuit. This circuit maintains a conjugate match for the in band frequencies while phase shifting the out of band frequencies to be substantially an open circuit. Conjugate matching is achieved when the output impedance of a circuit has the same real part with equal magnitude but opposite sign imaginary part as the circuit's load impedance. For instance if the output impedance of a transceiver is 50−j30 ohms, then the diplexing network would need to present 50+j30 ohms to be conjugately matched. Conjugate matching is necessary for maximum power transfer.

By using two diplexing networks coupled to the transceivers, the use of two switches may be avoided. That is, the use of two diplexing networks can minimize the number of SPDT switches in the circuit. The use of two diplexing networks can help to reduce the losses in the signal path that might otherwise exist were a switch used in place of the diplexing network. Switches are generally larger than the components in the diplexing network. The components in a diplexing network are typically reused as part of a matching network already included in the circuit. The first and second diplexing networks are tuned to the frequency of their respective transceivers. A diplexer is only created when the probe closes the RF connector to the second position and couples the two diplexing networks to the RF connector. The two inputs would be the transceiver side of the diplexing networks and the one output would be the probe connection. Essentially, each diplexing network is half a diplexer.

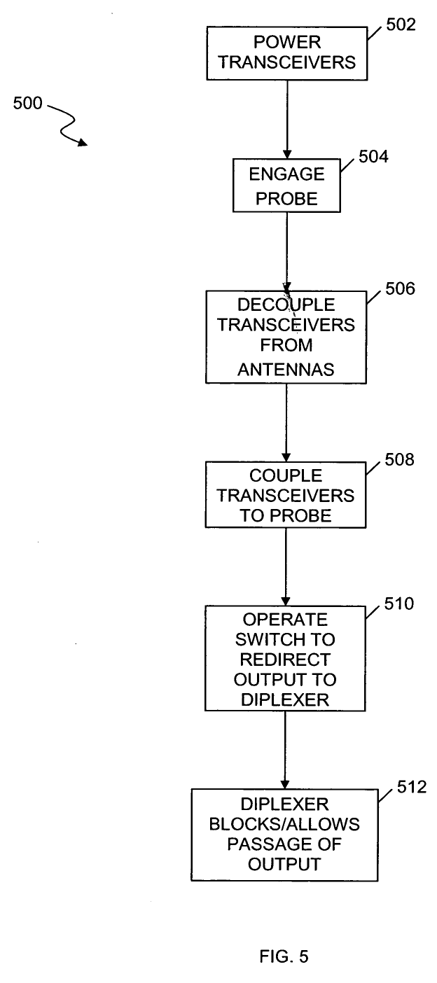

The disclosed methods can include operations of the circuit while inserting the probe, switching the coupling of the connector to one or the other of the transceivers and removing the probe, returning the transceivers to their connections with their respective antennas. FIG. 5 shows an embodiment of a method 500 for inserting the probe for testing of an electronic device including a connector having a probe port, the electronic device further including a plurality of transceivers coupled with corresponding antennas. The transceivers are powered up 502, and a probe is engaged with the probe port so as to perform testing 504. Accordingly, when the probe is engaged with the probe port, the transceivers and the antennas can be decoupled from one another 506. Then the transceivers can be coupled 508 to the probe port through the connector. The switch operates 510 to redirect an output of a transceiver from an antenna to a diplexing network to enable coupling of the transceiver with the RF connector, and thus the probe. At the same time, the diplexing network can allow or block passage 512 of signals as appropriate, for example, blocking an output from a second transceiver from being applied to a first transceiver through the output connection of the first transceiver.

In an embodiment in which more than two transceivers are provided in a mobile communication device, for example, three transceivers, the devices and methods described herein can be adjusted accordingly. For example, a third transceiver may be configured with a switch and a third diplexing network. The additional switch may be operated using the same detection circuitry and switch control as preciously discussed. The third diplexing network may be configured so that signals in the frequency range at which the third transceiver transmits and receives are in-band for the third diplexing network, and so that signals in the frequency ranges at which the first transceiver 404 and the second transceiver 406 transmit and receives are out-of-band for the third diplexing network.

Similarly, in this embodiment with three transceivers, the first diplexing network may be configured so that signals in the frequency range at which the first transceiver transmits and receives are in-band for the first diplexing network, and configured so that signals in the frequency ranges at which the second and third transceivers transmit and receive are out-of-band for the first diplexing network. In addition, the second diplexing network may be configured so that signals in the frequency range at which the second transceiver transmits and receives are in-band for the second diplexing network, and configured so that signals in the frequency ranges at which the first and third transceivers transmit and receive are out-of-band for the second diplexing network. Moreover, in the case where there may be many transceivers, the designers of the mobile communication device can of course include more than one of the circuit as described here. In that way, the number of probe ports can be limited. In this case, these diplexing networks are triplexing networks.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A communication device, comprising:
a plurality of transceivers;
a plurality of antennas; and
a probe port;
wherein in a first configuration the transceivers are coupled to their respective antennas, and in a second configuration the transceivers are configured to send signals to and receive signals from the probe port.

2. The communication device of claim 1, wherein the plurality of transceivers comprises a first transceiver and a second transceiver and the plurality of antennas comprises a first antenna and a second antenna, the device further comprising:
a diplexing network coupled to the first transceiver;
a connector comprising the probe port and coupled to the diplexing network; and
a switch coupled to the second transceiver;
wherein in the first configuration the connector couples the diplexing network to the first antenna and the switch couples the second transceiver to the second antenna.

3. The communication device of claim 2, wherein the diplexing network is configured to substantially pass to the connector signals from the first transceiver, and to substantially block signals from the second transceiver applied to the connector from reaching the first transceiver.

4. The communication device of claim 2, wherein the diplexing network comprises a first diplexing network, the device further comprising:
a second diplexing network;
wherein in the second configuration the connector couples the first diplexing network and the second diplexing network to the probe port and the switch couples the second transceiver to the second diplexing network.

5. The communication device of claim 4, wherein the second diplexing network is configured to substantially pass to the connector signals of the second transceiver applied to the switch in the second configuration, and to substantially block signals from the first transceiver applied to the connector from reaching the switch.

6. The communication device of claim 4, further comprising:
a detection circuitry module operable to detect when the connector couples the first diplexing network and the second diplexing network to the probe port.

7. The communication device of claim 6, further comprising:
a switch control module operatively connected between the detection circuitry module and the switch;
wherein when the detection circuit module detects that the connector couples the first diplexing network and the second diplexing network to the probe port, the switch control operates the switch to connect the second transceiver to the second diplexing network.

8. The communication device of claim 4, further comprising:
a probe configured for engaging with the probe port;
wherein engaging the probe with the probe port actuates the connector to couple the first diplexing network and the second diplexing network to the probe port.

9. The communication device of claim 5, wherein the plurality of transceivers further comprises a third transceiver, the plurality of antennas further comprises a third antenna, and the switch comprises a first switch, the communication device further comprising:
a third diplexing network; and
a second switch coupled to the third transceiver;
wherein in the first configuration the second switch couples the third transceiver to the third antenna, and in the second configuration the connector further couples the third diplexing network to the probe port and the second switch couples the third transceiver to the third diplexing network.

10. The communication device of claim 1, wherein the communication device comprises a cellular telephone.

11. A communication device, comprising:
a first transceiver functional to receive over a first antenna, the first transceiver comprising a first diplexing network and a connector for attaching to the first antenna; and
at least a second transceiver functional to receive over a second antenna, the second transceiver comprising a switch and a second diplexing network;
wherein the switch is operatively connected between the second transceiver and the second antenna in a first position, and between the second transceiver and the second diplexing network in a second position.

12. The communication device of claim 11, wherein the connector comprises a probe port, and wherein the connector has an antenna position and a probe position, the connector configured to couple the first diplexing network to the first antenna when the connector is in the antenna position, and to couple the first diplexing network and the second diplexing network to the probe port when the connector is in the second position.

13. The communication device of claim 12, further comprising:
a probe configured for engaging with the probe port.

14. The communication device of claim 13, wherein the connector normally occupies the antenna position, and wherein engaging the probe with the probe port shifts the connector to the probe position.

15. The communication device of claim 11, further comprising:
a third transceiver functional to receive over a third antenna, the third transceiver comprising a second switch and a third diplexing network;
wherein the second switch is operatively connected between the third transceiver and the third antenna in a first position, and between the third transceiver and the third diplexing network in a second position

16. The communication device of claim 11, further comprising:
a detection circuitry module operable to detect when the connector is in the probe position; and
a switch control module operatively connected between the detection circuitry module and the switch;
wherein when the detection circuit module detects that the connector is in the probe position, the switch control operates the switch to connect the second transceiver to the second diplexing network.

17. A method for testing an electronic device comprising a connector having a probe port, the electronic device further comprising a plurality of transceivers coupled with corresponding antennas, the method comprising:
powering up the plurality of transceivers; and
engaging the probe port with a probe so as to perform testing;
wherein engaging the probe port with the probe decouples the plurality of transceivers from the plurality of antennas and couples the plurality of transceivers to the probe port.

18. The method of claim 17, wherein the electronic device further comprises a plurality of switches and a plurality of diplexing networks, the method further comprising:
operating a switch to redirect an output of a transceiver from an antenna to a diplexing network; and
blocking passage with the diplexing network of an output from a second transceiver into the first transceiver.

19. The method of claim 17, further comprising:
engaging the probe port with a probe so as to connect an accessory.

20. The method of claim 17, wherein the electronic device comprises a communication device.
